(19) United States
(12) Patent Application Publication
(10) Pub. No.: US 2001/0043711 A1
(43) Pub. Date: Nov. 22, 2001

(54) Headphone

(76) Inventors: Junichi Hashimoto, Neyagawa-shi (JP); Eiichi Takakura, Neyagawa-shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/849,999

(22) Filed: May 8, 2001

(30) Foreign Application Priority Data
May 19, 2000 (JP) P 2000-147690

(51) Int. Cl. H04R 25/00

(52) U.S. Cl. 381/370; 381/371; 381/374

(57) ABSTRACT

A headphone includes first and second housing assemblies, a first cord connected to the first housing assembly and to a plug, a second cord connected to the first housing assembly or the first cord and to the second housing assembly, and a slider slidably mounted on the second cord. The slider acts to change the length of the second cord between the first housing assembly and the slider and between the second housing assembly and the slider, making it possible to reduce the slack in the second cord to improve the appearance of the headphone.

### BACKGROUND OF THE INVENTION

1. Field of the Invention

The present invention relates to a headphone for use with portable acoustic appliances or the like.

2. Description of the Related Art

Recently, headphones are increasingly utilized with the development of portable acoustic appliances. Conventional headphones are of the type to fit over the head with the use of a headband or of the type to be inserted into the ears. In addition thereto, headphones of the ear-hanging type which are to be hung on the ears with the use of ear clamps are frequently used.

In general, small-sized headphones are to be connected to the portable acoustic appliances via a cord. As shown in FIG. 13, a cord 32, connected to an acoustic appliance 31, is led in a housing (not shown) for the left ear, from which a bridging cord 34 is branched. In some cases, the bridging cord 34 is branched from the cord 32 in the proximity of the housing. The bridging cord 34 is connected to another housing 33 for the right ear and, hence, passes in front of or behind the neck.

It is, however, the general practice that the bridging cord 34 is made a little on the long side so as to fit anyone. Such a bridging cord 34 looks unattractive because a surplus length thereof swings or gets entangled. In the crowded trains or the like, there is a good chance that the bridging cord 34 gets caught in someone else's belongings or hair.

### SUMMARY OF THE INVENTION

The present invention has been developed to overcome the abovedescribed disadvantages.

It is accordingly an objective of the present invention to provide an easy-to-use headphone that looks attractive and has a means for reducing slack of the bridging cord to securely hold the headphone.

In accomplishing the above and other objectives, the headphone according to the present invention includes a first housing assembly having a first electroacoustic transducer accommodated therein, a second housing assembly having a second electroacoustic transducer accommodated therein, a first cord drawn into the first housing assembly and having a plurality of signal lines connected to the first and second electroacoustic transducers, and a second cord extending outwardly from the first housing assembly and drawn into the second housing assembly. Some of the plurality of signal lines run through the second cord and are connected to the second electroacoustic transducer. The headphone according to the present invention also includes a slider having two substantially parallel through-holes defined therein through which the second cord extends to hold the slider. The slider is slidable along the second cord and acts to change a length of the second cord between the first housing assembly and the slider and between the second housing assembly and the slider.

Alternatively, the first cord has a junction, from which the second cord is branched.

By the above-described construction, after the first and second housing assemblies have been fit on both ears, the slider can be moved towards the housing assemblies along the second cord to reduce sack of the second cord, making it possible to improve the appearance of the headphone and to securely hold the two housing assemblies on both ears. Further, the tightened second cord won't be an obstacle to the user.

It is preferred that the second cord be covered with a woven textile.

The woven textile may be interwoven with a plated or colored wire.

The woven textile or the plated or colored wire is soft and comfortable, and further improves the appearance of the headphone.

### BRIEF DESCRIPTION OF THE DRAWINGS

The above and other objectives and features of the present invention will become more apparent from the following description of preferred embodiments thereof with reference to the accompanying drawings, throughout which like parts are designated by like reference numerals, and wherein:

FIG. 1 is a front view of a first embodiment of a headphone according to the present invention;

FIG. 2A is a top plan view of a slider mounted on the headphone of FIG. 1;

FIG. 2B is a view similar to FIG. 2A, but depicting a modification thereof;

FIG. 3 is a wiring diagram of signal lines in the headphone of FIG. 1;

FIG. 4 is a bottom plan view of a housing assembly of the headphone of FIG. 1;

FIG. 5A is a horizontal sectional view of the housing assembly of FIG. 4;

FIG. 5B is a view similar to FIG. 5A, but particularly depicting an opened ear clamp;

FIG. 6 is a perspective view of the headphone of FIG. 1, when fitted on both ears of the user;

FIG. 7 is a view similar to FIG. 6, but particularly depicting the state in which a bridging cord has been tightened;

FIG. 8 is a perspective view of a portion of the headphone of FIG. 1 as viewed from the rear;

FIG. 9 is a perspective view of the headphone of FIG. 1 when carried in the users hand;

FIG. 10 is a front view of a second embodiment of the headphone according to the present invention;

FIG. 11 is a wiring diagram of signal lines in the headphone of FIG. 10;

FIG. 12 is a view similar to FIG. 8, but according to the second embodiment of the present invention; and

FIG. 13 is a perspective view of a conventional headphone, when fitted on both ears of the user.

### DETAILED DESCRIPTION OF THE PREFERRED EMBODIMENTS

This application is based on an application No. 2000-147690 filed May 19, 2000 in Japan, the content of which is herein expressly incorporated by reference in its entirety.

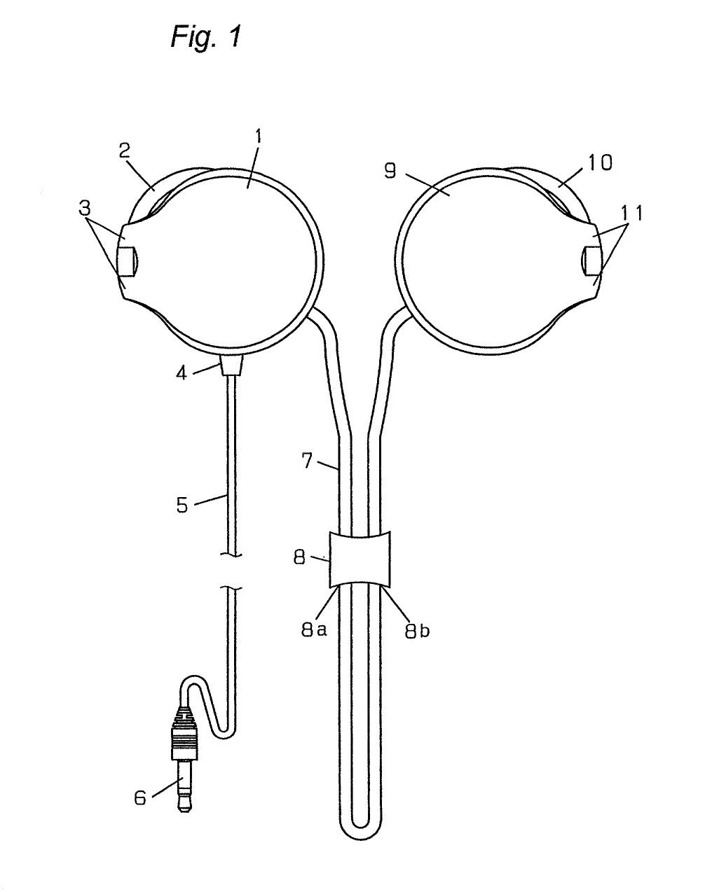

Referring now to the drawings, there is shown in FIG. 1 a first embodiment of a headphone according to the present invention. The headphone shown therein includes a first housing assembly 1 for the left ear and a second housing assembly 9 for the right ear, both of which are made of plastic or a metal.

The first housing assembly 1 accommodates a speaker unit (a first electroacoustic transducer discussed later) and has an ear clamp 2 mounted thereon so as to be rotatable about two shaft supports 3. The first housing assembly 1 also has a bushing 4 secured thereto at a lower portion thereof, through which a first cord 5 connected to the speaker unit extends outwardly. The first cord 5 has a plug 6 connected to a distal end thereof, which is to be connected to a portable acoustic appliance or the like.

A second cord or bridging cord 7 extends outwardly from the first housing assembly 1, passes through a first through-hole 8a defined in a slider 8, returns to the slider 8 in the form of a figure “U”, passes through a second through-hole 8b defined in the slider 8, and is finally introduced into the second housing assembly 9. By so doing, the slider 8 is held on the second cord 7. The first and second through-holes 8a, 8b are so formed as to be substantially parallel to each other and so sized as to allow the slider 8 to freely slide along the second cord 7. The slider 8 acts to change the length of the second cord 7 between the first housing assembly 1 and the slider 8 and between the second housing assembly 9 and the slider 8.

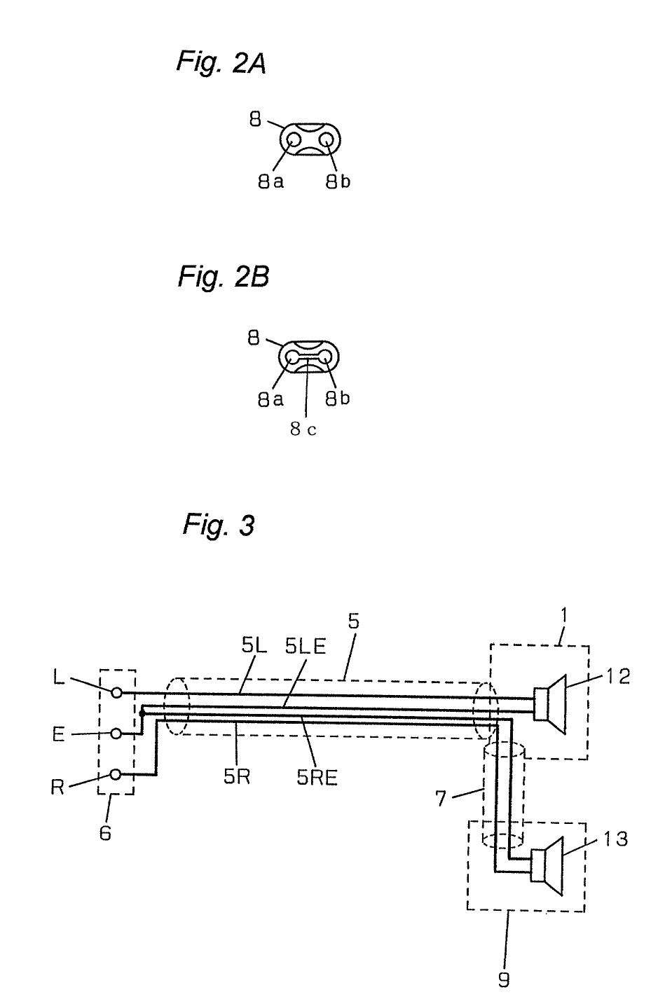

Although the slider 8 has two separate through-holes 8a, 8b, as shown in FIG. 2A, it may have two through-holes 8a, 8b that communicate with each other via a slit 8c, as shown in FIG. 2B. The slider 8 shown in FIG. 2A or 2B is of one-piece construction. However, the slider 8 may be formed into two generally flat blocks that can be mated to and separated from each other with a plane lying on the centerlines of the two through-holes as the border. In that case, the two generally flat blocks are made of soft plastic, and one of them has a protrusion, while the other has a recessed portion having a shape complementary to that of the protrusion for mutual engagement. The two generally flat blocks may be integrally formed with a hinge interposed therebetween. With this configuration, the hinge is connected at opposite sides thereof to the two generally flat blocks, while the protrusion and the recessed portion are formed on the latter on respective sides opposite to the hinge. The configurations other than the above are also possible.

As is the case with the first housing assembly 1, the second housing assembly 9 accommodates a speaker unit (a second electroacoustic transducer discussed later) and has an ear clamp 10 mounted thereon so as to be rotatable about shaft supports 11. The first and second housing assemblies 1, 9 are symmetric with respect to a plane.

The electrical connection for the headphone of the above-described construction is discussed hereinafter with reference to FIG. 3.

The speaker unit 12 for the left ear and the speaker unit 13 for the right ear are mounted in the first and second housing assemblies 1, 9, respectively, while a left terminal L, a right terminal R, and a common terminal E are all mounted in the plug 6. Signal lines 5L, 5LE connected to the left terminal L and the common terminal E and to the speaker unit 12, and signal lines 5R, 5RE connected to the right terminal R and the common terminal E and to the speaker unit 13 run through the first cord 5. The first cord 5 is drawn into the first housing assembly 1, from which the second cord 7 having the signal lines 5R, 5RE running therethrough is drawn out. The second cord 7 is then drawn into the second housing assembly 9 and connected to the speaker unit 13. Although FIG. 3 depicts the four signal lines extending through the first cord 5, the number of the signal lines may be reduced to three. In that case, a junction between the signal line 5LE and the signal line 5RE is located inside the first housing assembly 1 or in the proximity thereof.

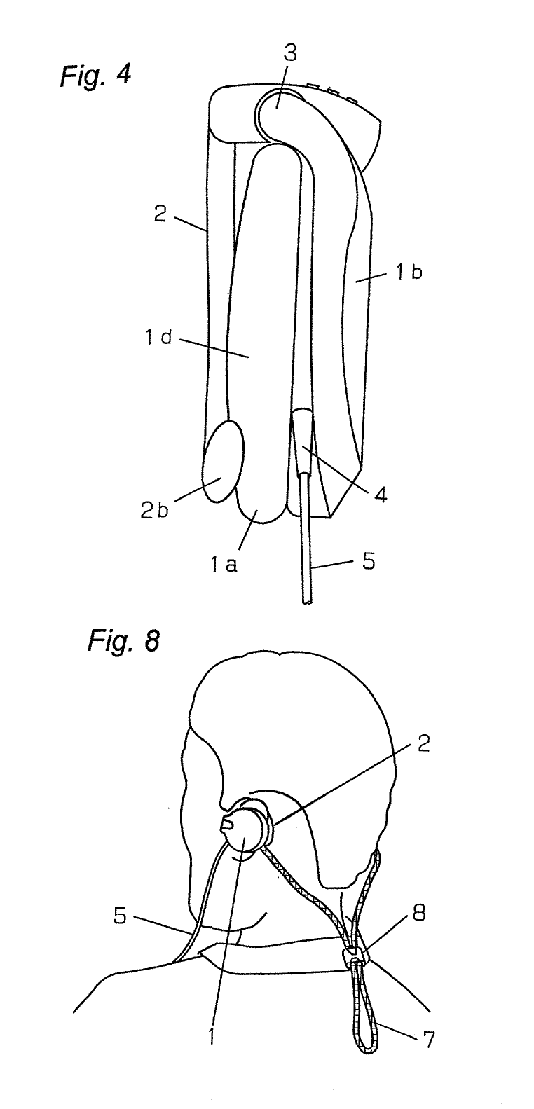

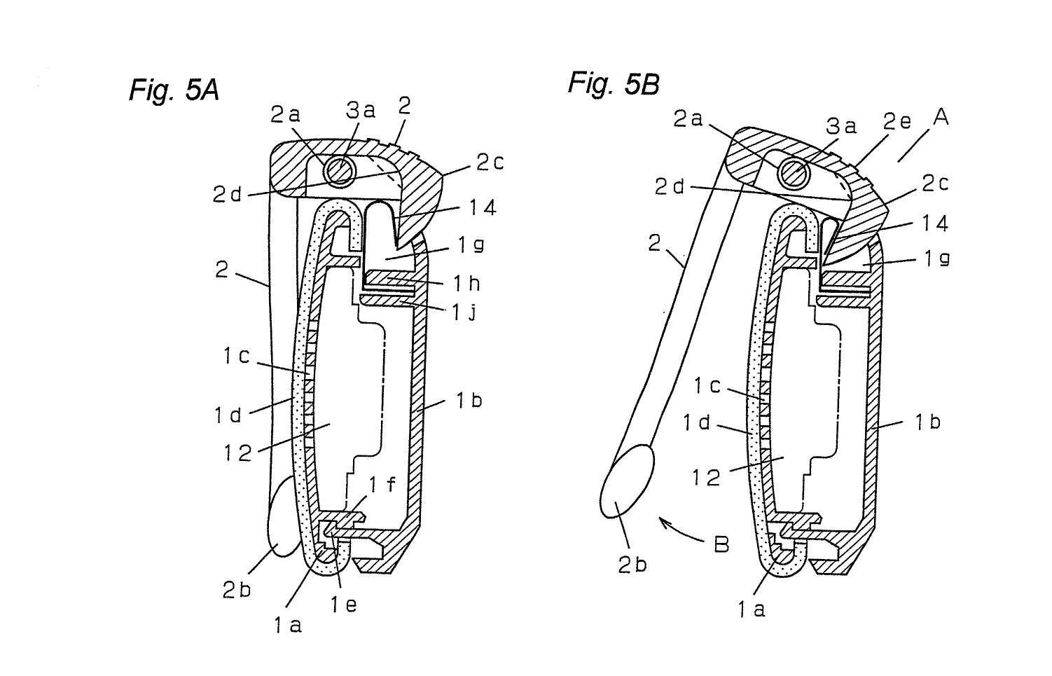

FIGS. 4, 5A and 5B depict the first housing assembly 1 for the left ear. As shown therein, the first housing assembly 1 includes a front housing 1a and a rear housing 1b. The front housing 1a has the speaker unit 12 mounted therein and a number of holes 1c defined therein at a location confronting a front face (left side in FIGS. 5A and 5B) of the speaker unit 12. The speaker unit 12 emits an acoustic output towards the front face thereof and through the holes 1c. The speaker unit 12 and the front face of the front housing 1a are covered with an ear pad 1d made of a soft and breathable material such as cloth, expanded polyurethane or the like. Sound emitted from the speaker unit 12 comes out of the ear pad 1 d.

The rear housing 1b has a plurality of hooks 1e integrally formed therewith, while the front housing 1a has a corresponding number of lock portions 1f integrally formed therewith. The front and rear housings 1a, 1b are assembled together by engaging the hooks 1e with the associated lock portions 1f. The rear housing 1b also has two shaft supports 3 integrally formed therewith so as to extend laterally outwardly therefrom. The two shaft supports 3 have respective shafts 3a integrally formed therewith so as to extend inwardly therefrom. Each of the shafts 3a is loosely inserted into a through-hole 2a defined in the ear clamp 2 to pivotally support the ear clamp 2 about it. The ear clamp 2 has a relatively short finger rest 2c formed on the opposite side of a free end 2b thereof with respect to the through-holes 2a. A spring 14 is located inside the finger rest 2c and accommodated in a recess 1g defined in the rear housing 1b. The spring 14 has one end, which is generally U-shaped and held in contact with an inner surface 2d of the finger rest 2c, and the other end that is bent by approximately 90° and inserted between two protrusions 1h, 1j integrally formed with the rear housing 1b. Although not shown in the drawings, the portion of the spring 14 that is positioned between the two protrusions 1h, 1j is bent in either the longitudinal or widthwise direction thereof so that the former may be firmly held by the latter. The spring 14 acts to bias the finger rest 2c outwardly i.e., in the direction in which the free end 2b of the ear clamp 2 moves towards the ear pad 1d.

The ear clamp 2 has a non-slip portion 2e formed outwardly of the finger rest 2c and having a plurality of relatively low protrusions.

Although the above explanation has been made with respect to only the first housing assembly 1 for the left ear, the same is true for the second housing assembly 9, because the first and second housing assemblies 1, 9 are symmetric with respect to a plane from which sound comes out.

The headphone of the above-described construction is fitted on the user's ears in the following manner.

The slider 8 is first positioned at a location apart from the first and second housing assemblies 1, 9. The first housing assembly 1 is then sandwiched in between the thumb and the index finger with the thumb on a lower portion thereof and the index finger on the finger rest 2c. As shown in FIG. 5B, when the finger rest 2c is pushed with the index finger in the direction of an arrow A, the free end 2b of the ear clamp 2 rotates about the shafts 3a in the direction of an arrow B against the biasing force of the spring 14, thereby causing the ear clamp 2 to move away from the front face of the front housing 1a. The first housing assembly 1 is then fitted on the left ear by inserting the ear clamp 2 in between a rear face of the auricle and the head and by releasing the index finger from the finger rest 2c.

The second housing assembly 9 can be fitted on the right ear in the same manner.

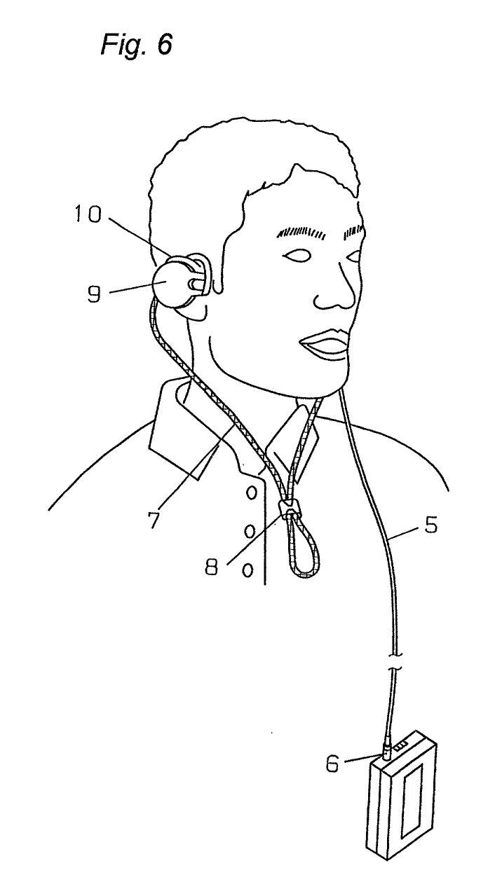

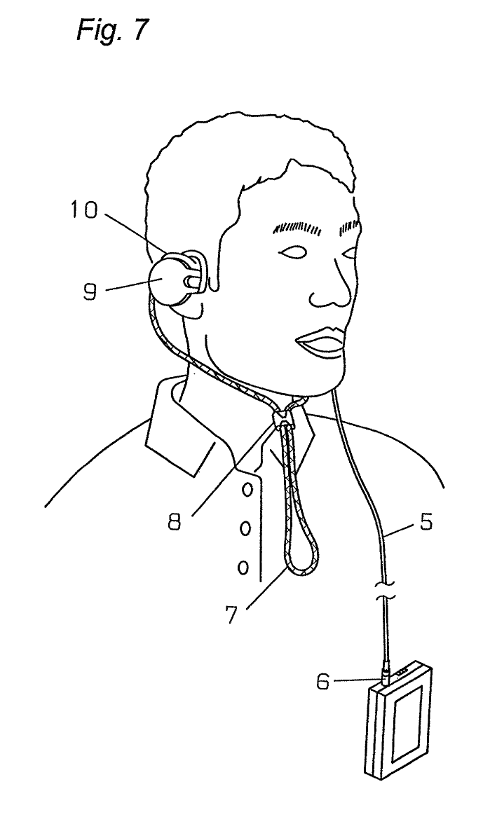

At this moment, the slider 8 is located in the proximity of the curved portion (U-shaped portion) of the second cord 7 that is then slack, as shown in FIG. 6. As shown in FIG. 7, a subsequent upward movement of the slider 8 reduces the slack in the second cord 7, making it possible to improve the appearance. Further, because the second cord 7 is positioned close to the chin, as similar to the chin strap of a hat, the ear clamps 2, 10 and the second cord 7 act to push the first and second housing assemblies 1, 9 towards the center of the head, thus ensuring the headphone fitting.

It is the general practice that the first and second cords 5, 7 are made of a soft synthetic resin such, for example, as vinyl chloride. It is, however, preferred that at least the second cord 7 be made of cloth that is woven of natural fiber (e.g. cotton) or synthetic fiber (e.g. polyester). The second cord 7 may be covered with a textile woven of such fiber. By so doing, the second cord 7 becomes soft and comfortable, and the appearance thereof is improved with a pattern of the web or textile. It is conceivable that the appearance of the second cord 7 is further improved by interweaving the woven textile with a plated or colored fine wire.

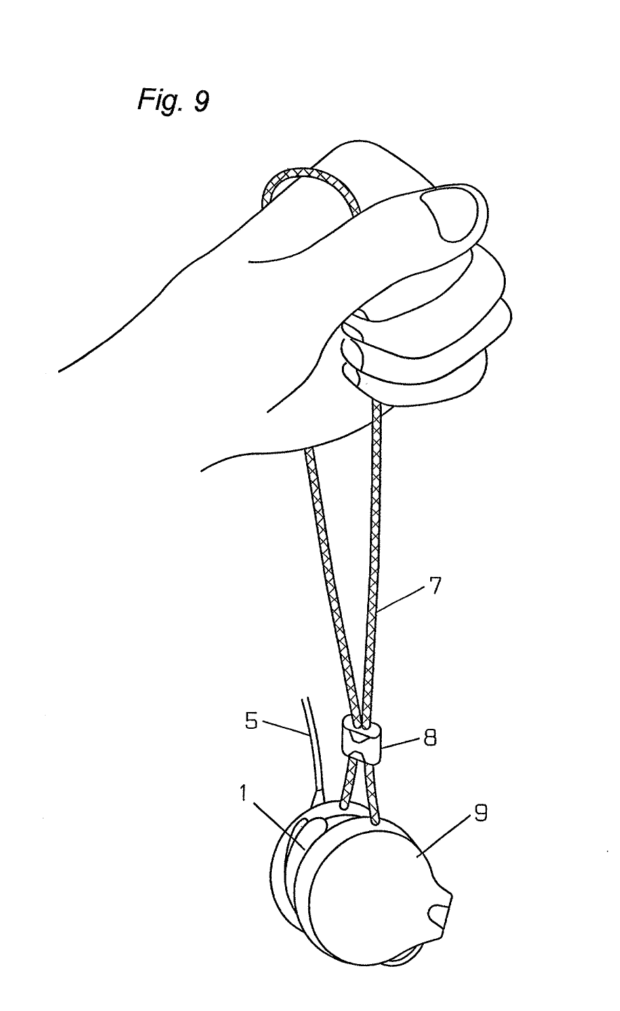

As shown in FIG. 8, the second cord 7 may be positioned behind the neck, or as shown in FIG. 9, it may be used to hang the headphone from the hand, like a handbag. With such styles, the headphone is easy to carry or the appearance thereof is improved.

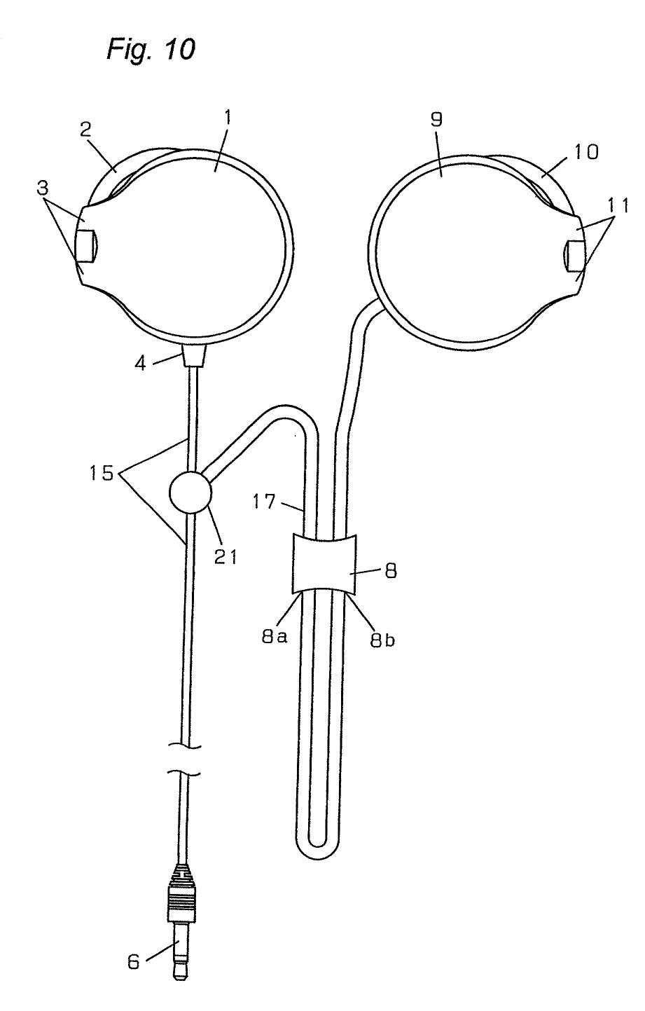

FIG. 10 depicts a second embodiment of the headphone according to the present invention. As shown therein, a first cord 15 extends outwardly from the bushing 4 secured to a lower portion of the first housing assembly 1. The first cord 15 has a junction 21 formed at a location spaced a distance apart from the bushing 4. At the junction 21, the first and second cords 15, 17 are joined together so that no load may be applied to the signal lines.

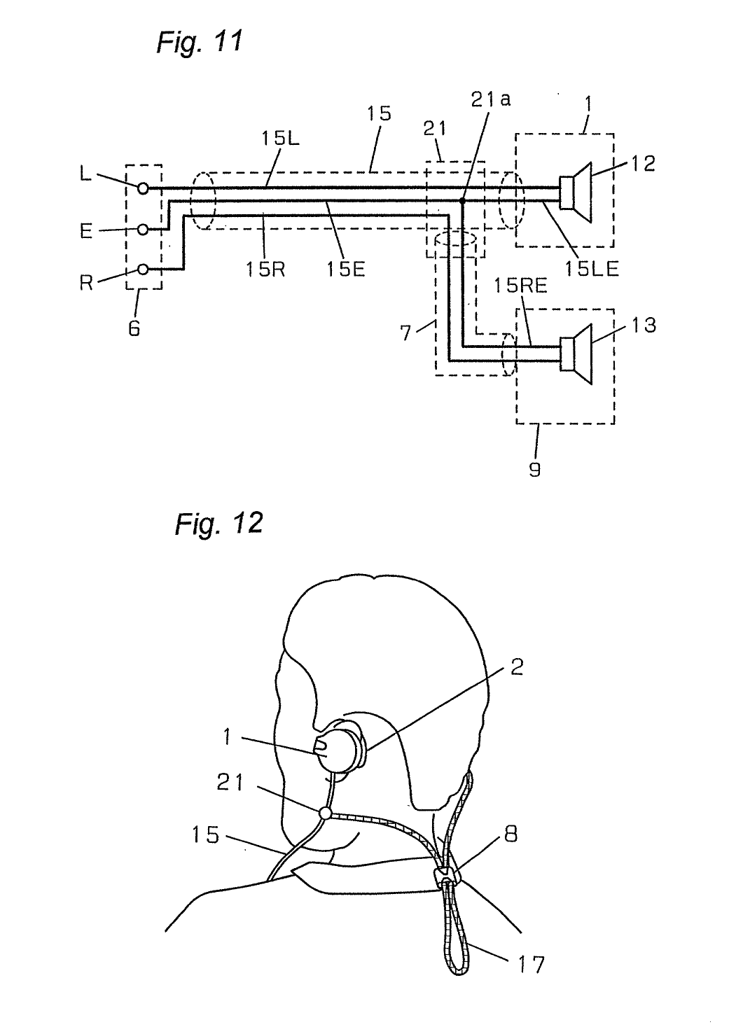

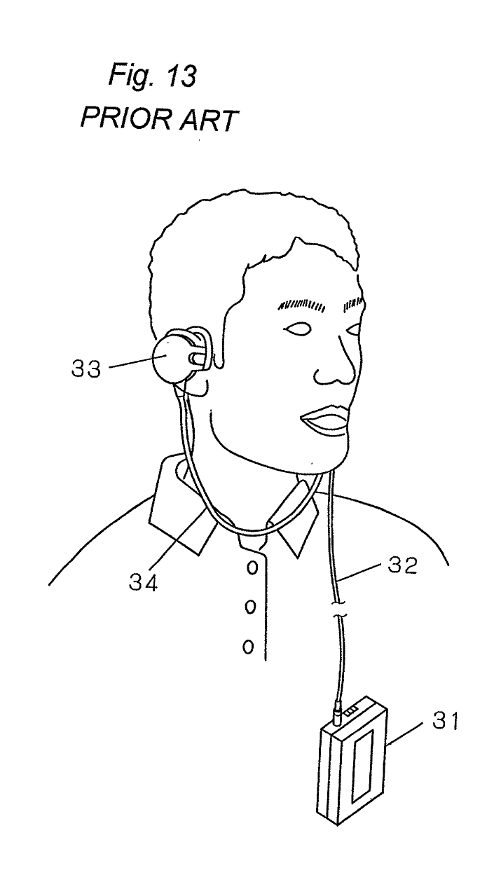

As shown in FIG. 11, signal lines 15L, 15E connected to the left terminal L and the common terminal E, respectively, and to the speaker unit 12, a branch line 15LE, and a signal line 15R connected to the right terminal R and to the speaker unit 13 run through the first cord 15. A portion of the signal line 15R and a signal line 15RE branched from a branch point 21 a in the junction 21 run through the second cord 17, which is drawn into the second housing assembly 9 and connected to the speaker unit 13.

FIG. 12 depicts the case wherein the slider 8 has been drawn up to the scruff of the neck, ensuring the headphone fitting.

Although in the above-described embodiments the first cord 5 or 15 is drawn into the first housing assembly 1 for the left ear, it may be drawn into the second housing assembly 9 for the right ear.

Moreover, although only the first housing assembly 1 has the bushing 4 for protecting the first cord 5 or 15, the second housing assembly 9 may have a bushing for protecting the second cord 7 or 17.

Although the present invention has been fully described by way of examples with reference to the accompanying drawings, it is to be noted here that various changes and modifications will be apparent to those skilled in the art. Therefore, unless such changes and modifications otherwise depart from the spirit and scope of the present invention, they should be construed as being included therein.

What is claimed is:

1. A headphone comprising:
a first housing assembly having a first electroacoustic transducer accommodated therein;
a second housing assembly having a second electroacoustic transducer accommodated therein;
a first cord drawn into said first housing assembly and having a plurality of signal lines connected to said first and second electroacoustic transducers;
a second cord extending outwardly from said first housing assembly and drawn into said second housing assembly, some of said plurality of signal lines running through said second cord and being connected to said second electroacoustic transducer; and
a slider having two substantially parallel through-holes defined therein through which said second cord extends to hold said slider;
wherein said slider is slidable along said second cord and acts to change a length of said second cord between said first housing assembly and said slider and between said second housing assembly and said slider.

2. The headphone according to claim 1, wherein said second cord is covered with a woven textile.

3. The headphone according to claim 1, wherein the woven textile is interwoven with a plated or colored wire.

4. A headphone comprising:
a first housing assembly having a first electroacoustic transducer accommodated therein;
a second housing assembly having a second electroacoustic transducer accommodated therein;
a first cord drawn into said first housing assembly and having a plurality of signal lines connected to said first and second electroacoustic transducers, said first cord also having a junction;
a second cord branched from said junction and drawn into said second housing assembly, some of said plurality of signal lines running through said second cord and being connected to said second electroacoustic transducer; and
a slider having two substantially parallel through-holes defined therein through which said second cord extends to hold said slider;
wherein said slider is slidable along said second cord and acts to change a length of said second cord between said first housing assembly and said slider and between said second housing assembly and said slider.

5. The headphone according to claim 4, wherein said second cord is covered with a woven textile.

6. The headphone according to claim 4, wherein the woven textile is interwoven with a plated or colored wire.
